(19) United States
(12) Patent Application Publication
(10) Pub. No.: US 2010/0171420 A1
(43) Pub. Date: Jul. 8, 2010

(54) PLASMA DISPLAY PANEL AND METHOD FOR MANUFACTURING THE SAME

(76) Inventors: Koji Akiyama, Osaka (JP); Koji Aoto, Hyogo (JP); Masaki Nishimura, Osaka (JP); Masaki Nishinaka, Osaka (JP)

Correspondence Address: WENDEROTH, LIND & PONACK L.L.P., 1030 15th Street, N.W., Suite 400 East, Washington, DC, 20005-1503, US

(21) Appl. No.: 12/663,938

(22) PCT Filed: Mar. 25, 2009
(86) PCT No.: PCT/JP2009/001309

§ 371 Date: Dec. 10, 2009

(30) Foreign Application Priority Data
Apr. 1, 2008 (JP) 2008-094662

(51) Int. Cl. H01J 17/49; H01J 9/26

(52) U.S. Cl. 313/582; 445/25

(57) ABSTRACT

A plasma display panel has a plurality of pairs of display electrodes, dielectric layer, and protective layer disposed on front glass substrate. Protective layer is formed of nano crystal particles, and the average particle diameter of the nano crystal particles is in the range of 10 nm to 100 nm. With this structure, in the plasma display panel, front glass substrate has a sufficient strength and occurrence of panel cracks is reduced.

### TECHNICAL FIELD

The present invention relates to a plasma display panel for use in a display device, for example, and a method for manufacturing the plasma display panel.

### BACKGROUND ART

The definition and screen size of a plasma display panel (hereinafter referred to as a PDP) can be increased, and thus a 100-inch-class television is commercialized. In recent years, application of a PDP to a high-definition television having the number of scanning lines at least twice that of the conventional National Television System Committee (NTSC) system has been promoted.

A PDP is basically formed of a front plate and a rear plate. The front plate has the following elements:
a glass substrate formed of sodium borosilicate glass by a float process;
display electrodes formed of stripe-shaped transparent electrodes and bus electrodes on one of the principle surfaces of the glass substrate;
a dielectric layer covering the display electrodes and serving as a capacitor; and
a protective layer formed of magnesium oxide (MgO) on the dielectric layer.

The rear plate has the following elements:
a glass substrate;
stripe-shaped address electrodes formed on one of the principle surfaces of the glass substrate;
a base dielectric layer covering the address electrodes;
barrier ribs formed on the base dielectric layer; and
a phosphor layer formed between each of the barrier ribs and emitting red, green, or blue light.

The front plate and the rear plate are hermetically sealed so that the sides of electrode forming surfaces are opposed to each other. A discharge gas of neon (Ne) and xenon (Xe) is sealed into a discharge space partitioned by the barrier ribs, at a pressure of 55 kPa to 80 kPa. In the PDP, applying an image signal voltage selectively to the display electrodes causes a discharge, and the ultraviolet light caused by the discharge excites the phosphor layers of the respective colors so that the phosphor layers emit red, green, and blue light. Thus a color image is displayed.

In such a plasma display device, a module is formed in the following manner. A panel predominantly composed of glass is held on the front side of a chassis member made of a metal, e.g. aluminum, and a circuit board that forms a driving circuit for lighting the panel is disposed on the rear side of the chassis member. An example of such a module is disclosed (see Patent Literature 1, for example).

Although a flat panel display, such as a PDP, has a large screen size, reduction in thickness and weight is demanded. For this reason, in conventional arts, the glass substrate used as a substrate has insufficient strength, and panel cracks occur in the strength tests after commercialization.

[Patent Literature 1] Japanese Patent Unexamined Publication No. 2003-131580

### SUMMARY OF THE INVENTION

A PDP of the present invention is a plasma display panel that has a plurality of pairs of display electrodes, a dielectric layer, and a protective layer on a front glass substrate. The protective layer is formed of nano crystal particles, and the average particle diameter of the nano crystal particles is in the range of 10 nm to 100 nm.

A method for manufacturing a PDP of the present invention is a method for manufacturing a plasma display panel by disposing a front glass substrate that has at least display electrodes, a dielectric layer, and a protective layer opposite to a rear glass substrate, and sealing the front and rear substrates with a sealing member. In any of a step of forming the protective layer using nano crystal particles, a step of forming the display electrodes, a step of forming the dielectric layer, and a step of disposing the front glass substrate opposite to the rear glass substrate, the front glass substrate is treated by a thermal process at a temperature at least 100° C. lower than the strain point temperature of the front glass substrate.

The present invention can provide a PDP where the strength of the glass substrate after commercialization as a PDP is ensured and panel cracks are difficult to occur.

### BRIEF DESCRIPTION OF DRAWINGS

FIG. 1 is a perspective view showing a structure of a PDP in accordance with an exemplary embodiment of the present invention.

FIG. 2 is a sectional view showing a structure of a front plate of the

PDP.

FIG. 3 is a diagram for explaining stresses caused in a cross section of a glass substrate.

### REFERENCE MARKS IN THE DRAWINGS

### 1 PDP

2 Front plate
3 Front glass substrate
4 Scan electrode
4a, 5a Transparent electrode
4b, 5b Metal bus electrode
5 Sustain electrode
6 Display electrode
7 Black stripe (light-blocking layer)
8 Dielectric layer
9 Protective layer
10 Rear plate
11 Rear glass substrate
12 Address electrode
13 Base dielectric layer

### 14 Barrier rib

15 Phosphor layer
16 Discharge space
20 Compressive stress layer
21 Compressive stress
30 Tensile stress layer
31 Tensile stress

### DETAILED DESCRIPTION OF PREFERRED EMBODIMENT

Hereinafter, a PDP in accordance with an exemplary embodiment of the present invention is demonstrated with reference to the accompanying drawings.

### Exemplary Embodiment

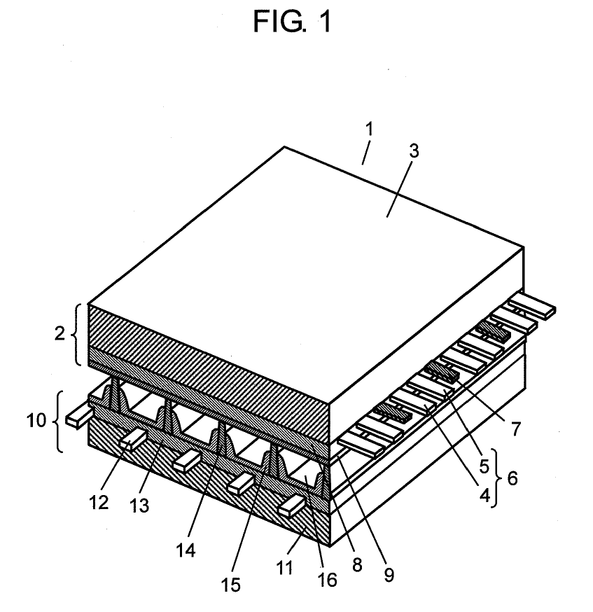

FIG. 1 is a perspective view showing a structure of a PDP in accordance with the exemplary embodiment of the present invention. The basic structure of the PDP is similar to that of a typical AC surface-discharge PDP. As shown in FIG. 1, in PDP 1, front plate 2 having front glass substrate 3 and rear plate 10 having rear glass substrate 11 are opposed to each other, and the outer peripheries of the plates are hermetically sealed with a sealing material containing a glass frit. In discharge space 16 inside of sealed PDP 1, a discharge gas containing neon (Ne) and xenon (Xe) is sealed at a pressure of 55 kPa to 80 kPa.

On front glass substrate 3 of front plate 2, a plurality of pairs of stripe-shaped display electrodes 6, each formed of scan electrode 4 and sustain electrode 5, and a plurality of black stripes (light-blocking layers) 7 are arranged parallel to each other. On front glass substrate 3, dielectric layer 8 serving as a capacitor is formed so as to cover display electrodes 6 and light-blocking layers 7. Further, protective layer 9 is formed of magnesium oxide (MgO), for example, on the surface of the dielectric layer.

On rear glass substrate 11 of rear plate 10, a plurality of stripe-shaped address electrodes 12 are arranged parallel to each other in the direction orthogonal to scan electrodes 4 and sustain electrodes 5 of front plate 2. Base dielectric layer 13 covers the address electrodes. Further, barrier ribs 14 having a predetermined height and partitioning discharge space 16 are formed on base dielectric layer 13 between address electrodes 12. To the grooves between barrier ribs 14, phosphor layer 15 caused to emit red, blue, or green color by ultraviolet light is sequentially applied for each address electrode 12. A discharge cell is formed in a position where scan electrode 4 and sustain electrode 5 intersect with address electrode 12. Discharge cells having red, blue, and green phosphors 15 arranged in the direction of display electrodes 6 form a pixel for color display.

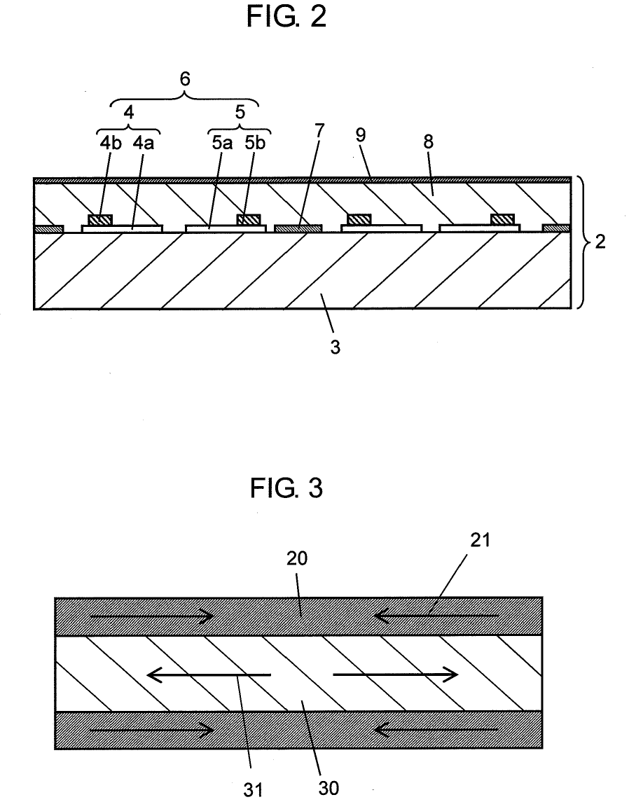

FIG. 2 is a sectional view of front plate 2 of the PDP in accordance with the exemplary embodiment of the present invention. FIG. 2 illustrates a vertically inverted state of FIG. 1. As shown in FIG. 2, display electrodes 6, each formed of scan electrode 4 and sustain electrode 5, and black stripes 7 are pattern-formed on front glass substrate 3 manufactured by a float process, for example. Scan electrode 4 and sustain electrode 5 are made of transparent electrodes 4a and 5a of indium tin oxide (ITO), tin oxide (SnO₂), or the like, and metal bus electrodes 4b and 5b disposed on transparent electrodes 4a and 5a, respectively. Metal bus electrodes 4b and 5b are used to impart conductivity in the longitudinal direction of respective transparent electrodes 4a and 5a, and are formed of a conductive material predominantly composed of silver (Ag).

Dielectric layer 8 covers these transparent electrodes 4a and 5a, metal bus electrodes 4b and 5b, and black stripes 7 formed on front glass substrate 3. Further, protective layer 9 is formed on dielectric layer 8.

Next, a description is provided for the strength of the glass substrate of the PDP.

As described above, in a PDP, reduction in weight and thickness is demanded while its screen size and definition are increased. For this reason, in order to maintain the strength of the PDP as a product at a current level, the strength of front glass substrate 3 and rear glass substrate 11 need to be further improved.

When a PDP is packed for product shipment, typically, the cushioning material is disposed only on the periphery of the PDP, and not on the image display part. Thus, when shock is given to the product by dropping the product with the side of front glass substrate 3 disposed in the downward direction during shipment, a force including the deadweight of the whole product is exerted on front glass substrate 3, and resulting deformation of front glass substrate 3 in a convex shape causes panel cracks.

On the other hand, suppose the product is dropped while the side of rear glass substrate 11 on the opposite side of the display surface is disposed in the downward direction. To rear glass substrate 11, which is the bottom face, a reinforcing plate that incorporates a driving circuit board and also works for heat dissipation is bonded. With this structure, the probability of causing panel cracks in rear glass substrate 11 is decreased. In this case, front glass substrate 3 is deformed into a concave shape, and panel cracks are more difficult to occur than when the substrate is deformed into a convex shape. In other words, panel cracks caused by shocks, such as a drop, are considerably influenced by the state of the image display surface side of front glass substrate 3.

The glass substrate of a PDP is typically formed by a float process. In the float process, blended glass raw materials are molten at a temperature of approximately 1600° C. and defoamed in a melting bath, and the defoamed material is floated and drawn in a float bath containing molten tin, so that a flat plate shape having a predetermined width and thickness is formed. Thereafter, the glass formed into a plate shape is rapidly cooled from approximately 600° C. to approximately 200° C. Thus strain and stress reside on the outermost surface of the glass substrate.

FIG. 3 is a drawing schematically showing stresses caused in a glass substrate formed by a float process, in a cross section of the glass substrate. As shown in FIG. 3, in the glass substrate, two types of stress layer are formed in the sectional direction. One is compressive stress layer 20 on the surfaces where compressive stress 21 is caused as a residual stress; the other is tensile stress layer 30 in the inside where tensile stress 31 is caused as a residual stress. These compressive stress layers 20 and tensile stress layer 30 are present in a balanced state, so that a flat plate is maintained as the shape of the glass substrate.

In contrast, as described above, when a shock is given during transportation with the side of front glass substrate 3 disposed as the bottom face, an external force for deforming the image display surface in a convex shape is exerted. Therefore, because the glass substrate formed by the float process is in a state where a compressive stress resides on the outermost surface of the substrate, the glass substrate is relatively resistant to such an external force of shock.

However, the inventors have found that the strength of the glass substrate changes as the glass substrate undergoes the PDP manufacturing steps. Specifically, when the residual stress in front glass substrate 3 is measured after the step of forming display electrodes, the step of forming a dielectric layer, the step of forming a protective layer, and the steps of sealing and evacuation, the stress is considerably decreased after each of the steps.

This is because thermal processes, such as the steps of firing the display electrodes and the dielectric layer, and the steps of sealing and evacuation, have large influence on the stress. In other words, it is considered as follows. In these thermal processes, the temperature of the glass substrate is increased to approximately 400° C. to 550° C., and thereafter decreased to a level of room temperature. During the temperature decrease, the whole glass substrate is cooled slowly, and the residual compressive stress caused in the glass substrate is reduced. Further, by repeating the increase and decrease in the temperature of the glass substrate, the residing compressive stress is further decreased.

In addition to this decrease in the compressive stress, in the manufacturing process of PDP 1, contact with a setter used in the firing step, and contact with a transfer roller used between the steps easily cause scars (micro-cracks) on the surfaces of the glass substrate. The micro-cracks further degrade the strength of the glass substrate.

As a result, in front glass substrate 3 of PDP 1 manufactured by the conventional art, the residing compressive stress decreases, and this decrease facilitates deformation of the image display surface in a convex shape caused by a shock during transportation, for example, and generation of panel cracks. The similar tendencies are verified from the results of the strength tests by packed product drop tests.

In contrast, in the exemplary embodiment of the present invention, the residual stress is maintained on the surface of front glass substrate 3 in a certain range. Thus PDP 1 where panel cracks are difficult to be caused by shocks is implemented.

The inventors have found that the value of residual stress necessary for accommodating to these shocks largely differs depending on the thickness and glass composition of the substrate. Particularly for a glass substrate made of lead-free components, even when the glass substrate has a residual stress similar to that of the conventional art, the strength in the drop tests considerably degrades. Thus it is difficult to maintain the conventional strength of the substrate and to ensure the factory productivity. According to these results, in the exemplary embodiment of the present invention, the residual stress of the substrate is set in the following ranges, by the type of front glass substrate 3 of PDP 1.

The stress of front glass substrate 3 on the surface opposite to the surface on which dielectric layer 8 is disposed is set so that the compressive stress is in the range of 0.8 MPa to 2.4 MPa. Particularly, when the thickness of the front glass substrate is 2.8 mm±0.5 mm, it is preferable to set the compressive stress in the range of 1.3 MPa to 2.4 MPa. When the thickness of the front glass substrate is 1.8 mm±0.5 mm, it is preferable to set the compressive stress in the range of 0.8 MPa to 1.7 MPa.

On the other hand, the glass substrate formed by the above float process in the initial state before the PDP manufacturing steps has the following values of residual stress. When the thickness of the substrate is 2.8 mm±0.5 mm, the residual stress is in the range of 1.3 MPa to 2.4 MPa. When the thickness of the substrate is 1.8 mm±0.5 mm, the residual stress is in the range of 0.8 MPa to 1.7 MPa.

Therefore, according to the studies of the inventors, maintaining the residual stress in the initial state can provide excellent results of no panel cracks in the packed product drop tests, for example. Thus a PDP where glass cracks are difficult to be caused even by shocks during transportation can be produced. Further, the strength of the substrate can be maintained and the productivity can be ensured.

In the exemplary embodiment of the present invention, the residual stress of the glass substrate is obtained by measuring the phase angle of deflected transmitted light. As a measuring device, a polarimeter (manufactured by Shinko Seiki Co., Ltd, SP-II type) is used. In principle, this stress measuring device is characterized in that different colors of the deflected transmitted light are observed for the compressive stress and tensile stress. Thus compressive stress or tensile stress can be determined.

The residual stress is measured at points on the image display surface of front glass substrate 3, i.e. the surface opposite to the surface on which the dielectric layer, or the like is formed. This is based on the consideration that the panel cracks in the packed product caused by shocks at a drop start from the side of the image display surface. The measured values in these points are clearly correlated with the results of the packed product drop tests to be described later.

Next, a description is provided for a method for manufacturing a PDP in accordance with the exemplary embodiment of the present invention.

As described above, in the conventional art, the stress caused in the glass substrate changes with the thermal processes, such as the firing step and the drying step when each component of PDP 1 is formed. In the exemplary embodiment of the present invention, in order to maintain the stress residing in the glass substrate in a fixed range, each component of the PDP is formed by a thermal process at temperatures lower than those of the conventional manufacturing method.

According to the results of the studies of the inventors, in order to maintain the residual stress in the glass substrate in the above range, PDP 1 needs to be manufactured in a temperature range at least 100° C. lower than the strain point temperature of the glass substrate. In other words, when front glass substrate 3 undergoes a thermal process in which this temperature is exceeded, the compressive stress residing in the glass substrate in the initial state decreases and deviates from the above residual stress range. As a result, glass cracks are easily caused by shocks during transportation, for example.

In the exemplary embodiment of the present invention, as front glass substrate 3, PD200 and soda lime glass AS manufactured by Asahi Glass Co., Ltd. are used. PD200 has a strain point of approximately 570° C. Thus PDP 1 is manufactured by a thermal process in which the temperatures of the surface of front glass substrate 3 are in a temperature range equal to or lower than 470° C. On the other hand, soda lime glass AS has a strain point of approximately 510° C. Thus PDP 1 is manufactured by a thermal process in which the temperatures of the surface of front glass substrate 3 are in a temperature range equal to or lower than 410° C. With these thermal processes, PDP 1 can be manufactured so that the residual stress in the initial state when the glass substrate is manufactured by the float process is maintained on the surface of front glass substrate 3.

In order to set the temperatures of the surface of front glass substrate 3 in the temperature range equal to or lower than 470° C. or in the temperature range equal to or lower than 410° C., the method for forming protective layer 9 is important. Typically, for protective layer 9, magnesium oxide (MgO) or other materials is formed by an electron beam (EB) vacuum evaporation method, for example. These materials have properties of easily adsorbing impurity gases, such as carbon dioxide gas and moisture. Thus protective layer 9 adsorbing impurity gases is bonded to rear plate 10 and PDP 1 is formed. These impurity gases are released into the discharge space by a discharge, change the discharge state, and may negatively affect the quality level of image display of PDP 1.

In order to prevent these negative influences, the conventional art includes a step of firing protective layer 9 at a temperature of approximately 550° C. after formation, or a step of keeping the protective layer at a high temperature during sealing and evacuation so that these impurity gases desorb from protective layer 9. However, as described above, the compressive stress residing in front glass substrate 3 is reduced by these steps, and the glass cracks are easily caused by shocks during transportation.

In contrast, in the exemplary embodiment of the present invention, in order to maintain the compressive stress caused in front glass substrate 3, PDP 1 is manufactured so that the PDP has protective layer 9 adsorbing only a small amount of impurity gas and front glass substrate 3 has a surface temperature at least 100° C. lower than the strain point temperature of front glass substrate 3.

Hereinafter, a method for manufacturing a PDP of the exemplary embodiment of the present invention is detailed. Here, a description is provided for a method for manufacturing PDP 1 using the soda lime glass AS as front glass substrate 3, by a thermal process in which the temperatures of front glass substrate 3 are in the temperature range equal to or lower than 410° C. The advantage of the present invention can also be provided by the manufacturing method of using PD200 as front glass substrate 3 and setting the temperatures of front glass substrate 3 in the temperature range equal to or lower than 470° C.

In the exemplary embodiment of the present invention, when the temperature of front glass substrate 3 is measured, in consideration of measurement of high temperatures, a K-type thermocouple is used in contact with the surface of the glass substrate. The measurement errors in this case are in the range of approximately ±5° C.

First, scan electrodes 4 and sustain electrodes 5, and light-blocking layers 7 are formed on front glass substrate 3 in the initial state. Transparent electrodes 4a and 5a are formed by a thin-film process, such as a sputtering method, and patterned into a desired shape by a photolithography method, for example.

Here, a method for forming metal bus electrodes 4b and 5b is detailed. In the conventional arts, typically, after a paste containing a photosensitive component, glass component, and conductive component is applied by a screen printing method, and patterned by a photolithography method, for example, the pattern is fired at a temperature of 560° C. to 600° C. for vitrification of the glass component contained to maintain the shape. However, as described above, in such a method, the compressive stress residing in the glass substrate decreases, and the advantage of the present invention cannot be obtained.

Thus, in the exemplary embodiment of the present invention, the following manufacturing method is used so that the firing temperature in the firing is set to a temperature at least 100° C. lower than the strain point temperature of the glass substrate.

A metal paste for fine wiring is used as a material for forming metal bus electrodes 4b and 5b. This paste is made by dispersing silver (Ag) particles several nanometers in size (hereinafter referred to as metal nanoparticles) at room temperature, using a dispersant (hereinafter, the paste being referred to as a nano Ag paste). In this nano Ag paste, the dispersant can be removed by heating, and the metal nanoparticles are sintered by a particle effect to form a conductive film.

In the exemplary embodiment of the present invention, as a nano Ag paste, paste NPS or NPS-HTB manufactured by Harima Chemicals, Inc. is used. One of these types of nano Ag paste is applied onto a substrate by a screen printing method, using a screen having a predetermined pattern formed therein. For paste NPS, heat treatment is performed at temperatures of 210° C. to 230° C. for 60 min, as a drying and firing step. For paste NPS-HTB, after a drying step is performed at temperatures of 200° C. to 240° C. for 10 min, a firing step is performed at temperatures of 300° C. to 350° C. for 30 to 60 min.

Other than the nano Ag paste, a vacuum thin-film forming process, such as a sputtering method, can be used to form a metal single-layer film, or a metal multi-layer film of chromium/copper/chromium or chromium/aluminum/chromium, for example. However, in this case, the temperature of the glass substrate needs to be set to 410° C. or lower. Further, after such thin-film formation, a resist layer is formed, and a pattern is formed by a photolithography method.

By either of the above methods of using the nano Ag paste and using the vacuum thin-film formation, metal bus electrodes 4b and 5b are formed. Thereby, the compressive stress residing in front glass substrate 3 can be maintained at a value in the initial state when the glass substrate is manufactured.

Similarly, light-blocking layers 7 are formed by screen-printing a paste containing a black pigment, or by forming a black pigment on the entire surface of the glass substrate and then patterning the pigment by a photolithography method and firing it. Also in this case, the temperature of front glass substrate 3 needs to be set to 410° C. or lower.

Next, a description is provided for dielectric layer 8. First, a dielectric paste layer (not shown) is formed by applying a dielectric paste to front glass substrate 3 by screen printing, die coating, or other methods so that the paste covers scan electrodes 4, sustain electrodes 5, and light-blocking layers 7. Thereafter, the dielectric paste layer is left for a predetermined time period, so that the surface of the applied dielectric paste layer is leveled to form a flat surface.

In the conventional art, the dielectric paste is a paint that contains a dielectric layer material, e.g. glass powder, as well as a binder, and a solvent. After the above steps, for vitrification of the glass powder, the dielectric paste is fired at temperatures of 550° C. to 600° C., which are in the vicinity of the softening point temperature of the dielectric layer material. However, in this art, the compressive stress residing in the glass substrate decreases, and thus the advantage of the present invention cannot be obtained.

In contrast, in the exemplary embodiment, a paste prepared in the following manner is used. Approximately 50 wt % to 60 wt % of silica particles are dispersed in a mixed liquid of a resin binder made of an oligomer having siloxane bonds, and a solvent, e.g. methyl ethyl ketone and isopropyl alcohol. As the resin binder, GLASCA manufactured by JSR Corporation is used. As the silica particles, IPA-ST manufactured by Nissan Chemical Industries, Ltd. is used.

This paste is applied to front glass substrate 3 by a die coating method so as to cover scan electrodes 4, sustain electrodes 5, and light-blocking layers 7. After the paste is dried at 100° C. for 60 min, the paste is fired at 250° C. to 350° C. for 10 min to 30 min. In this exemplary embodiment, the thickness of dielectric layer 8 after firing is approximately 12 μm to 15 μm.

In the exemplary embodiment of the present invention, dielectric layer 8 can also be formed by a sol-gel process. The sol-gel process is a method for changing a sol in which metal alkoxide particles are dispersed in a colloidal state into a gel of which fluidity is lost by hydrolysis and condensation polymerization reaction, and forming dielectric layer 8 by heating the gel. Here, in order to form dielectric layer 8 containing substantially no lead components, a silicon dioxide (SiO₂) film is made from tetraethoxysilane (TEOS) as a raw material.

Other than the sol-gel process, a silicon dioxide (SiO₂) film can be made from tetraethoxysilane (TEOS) as a raw material by a plasma chemical vapor deposition (CVD) method. Also in this case, it is necessary to set the temperature of front glass substrate 3 to 410° C. or lower.

Next, a description is provided for a method for forming protective layer 9. As described above, the exemplary embodiment of the present invention requires protective layer 9 adsorbing only a small amount of impurity gas. For this purpose, in the exemplary embodiment of the present invention, single-crystal particles of magnesium oxide (MgO) in nanometer size (hereinafter, nano crystal particles) are used to form protective layer 9. With such particles, the amount of impurity gas adsorbed by protective layer 9 can be considerably reduced.

Such magnesium oxide (MgO) particles in nano size are produced by an instantaneous gas-phase formation method. In this method, magnesium oxide (MgO) evaporated by energization of plasma, for example, is instantaneously cooled by cooling gas containing reaction gas, to form micro-particles in nano size. In the exemplary embodiment of the present invention, nano crystal particles 5 nm to 200 nm in particle diameter produced in Hosokawa Powder Technology Institute are used.

Then, a paste is produced in the following manner. Into a vehicle made by mixing 60 wt % of terpineol, 30 wt % of butyl carbitol acetate, and 10 wt % of acryl resin EMB-001 manufactured by Mitsubishi Rayon Co., Ltd., for example, the equivalent weight of nano crystal particles are kneaded. This paste is applied to the substrate by screen printing or other methods, dried at 100° C. to 120° C. for 60 min, and thereafter fired at 340° C. to 360° C. for 60 min. In protective layer 9 thus produced, the amount of adsorbed impurity gas can be reduced in comparison with that of protective layer 9 formed by the conventional EB vacuum evaporation method, for example.

Preferably, the thickness of protective layer 9 after firing is in the range of 0.5 μm to 2 μm, which is necessary for charge retention.

The inventors have verified by thermal desorption spectroscopy (TDS analysis) that the amount of adsorbed impurity gas is reduced. In the TDS analysis, a protective layer formed by the EB vacuum evaporation method typically used in the conventional art (hereinafter, an EB evaporated film) is compared with a protective layer formed of nano crystal particles (hereinafter, a nano crystal particle film) having an average particle diameter in the range of 5 nm to 200 nm.

As a result, in the nano crystal particle film, the amounts of adsorbed moisture, carbon dioxide, CH-based gases are considerably reduced in comparison with those in the EB evaporated film. Specifically, whereas the amount of desorbing gas rapidly increases at 350° C. to 400° C. for the EB evaporated film, such an increase is not observed for the nano crystal particle film.

Further, the inventors have found that when the average particle diameter of these nano crystal particles is 10 nm to 100 nm, the transmittance of protective layer 9 to visible light is not affected and the emission efficiency of PDP 1 is not decreased. It is also found, when the average particle diameter of the nano crystal particles is 10 nm to 100 nm, the PDP that has such nano crystal particles exhibits higher strength than a PDP that has a protective layer formed by other manufacturing methods, in drop tests, for example. This result will be detailed later.

With the above steps, predetermined constituents, i.e. scan electrodes 4, sustain electrodes 5, light-blocking layers 7, dielectric layer 8, and protective layer 9, are formed on front glass substrate 3. Thus front plate 2 can be completed so that the residual stress in the initial state is maintained in front glass substrate 3.

On the other hand, rear plate 10 is formed in the following manner. First, a material layer that constitutes address electrodes 12 is formed by a method for screen-printing a paste containing silver (Ag) material on rear glass substrate 11, a method for forming a metal film on the entire surface and then patterning the film by a photolithography method, or the like. Thereafter, the material layer is fired at a predetermined temperature, so that address electrodes 12 are formed.

Next, a dielectric paste layer is formed by applying a dielectric paste, by die coating or other methods, to rear glass substrate 11 that has address electrodes 12 formed thereon so that the dielectric paste covers address electrodes 12. Thereafter, the dielectric paste layer is fired, to form base dielectric layer 13. The dielectric paste is a paint containing a dielectric material, e.g. glass powder, as well as a binder, and a solvent.

Then, a barrier-rib forming paste that contains barrier-rib materials is applied to base dielectric layer 13 and patterned into a predetermined shape, to form a barrier-rib material layer. Thereafter, the material layer is fired, to form barrier ribs 14. Here, the methods for patterning the barrier-rib forming paste applied to base dielectric layer 13 include a photolithography method and a sand blast method. Thereafter, a phosphor paste containing phosphor materials is applied to base dielectric layer 13 between adjacent barrier ribs 14 and the side faces of barrier ribs 14, and fired. Thus phosphor layers 15 are formed. With the above steps, rear plate 10 having predetermined components on rear glass substrate 11 is completed.

Front plate 2 and rear plate 10 having predetermined components in this manner are opposed to each other so that scan electrodes 4 are orthogonal to address electrodes 12. Then, after the peripheries of the plates are sealed and discharge space 16 is evacuated, a discharge gas containing neon (Ne) and xenon (Xe) is sealed into the discharge space. Thus PDP 1 is completed.

These sealing and evacuation steps are performed in the following manner. Before sealing, a sealing member is applied in predetermined positions on the periphery of front plate 2 or rear plate 10, and dried for a predetermined time period. Thereafter, front plate 2 is disposed opposite to rear plate 10 so that display electrodes 6 of front plate 2 intersect with address electrodes 12 of rear plate 10, and the plates are fixed by a fixture, for example.

An example of sealing members for use in the conventional art is in the form of a paste made by mixing a low-melting crystallized frit glass and predetermined filler and kneading the mixture with an organic solvent. The sealing members are solidified by firing at temperatures of approximately 460° C. to 550° C. However, in such a method, the compressive stress residing in the glass substrate decreases and thus the advantage of the present invention cannot be obtained.

In contrast, in the exemplary embodiment of the present invention, an ultraviolet (UV) curing material is used as the material of a sealing member. With this material, the sealing and evacuation steps can be performed at low temperatures unattainable with the conventional art, and the stress residing in the glass substrate can be maintained. Specifically, UV curing sealant TU7113 manufactured by JSR Corporation is used as a sealing member. Such a sealant is made into the form of a paste, and applied as a sealing member, using an applicator having a dispenser.

Thereafter, front plate 2 and rear plate 10 are temporarily fixed so that the sealing members are crimped. The sealing members are irradiated with ultraviolet light and the temperature is increased to 150° C. for 30 min, so that the sealing members are cured. Thus the sealing step is completed.

Next, the gas in PDP 1 is removed. In order to facilitate desorption of gas physically adsorbed to the inside of PDP 1, the temperature is increased to and kept at approximately 200° C. for approximately 60 min. Thereafter, a discharge gas containing neon (Ne) and xenon (Xe) is sealed into discharge space 16 at a predetermined pressure (for a Ne-Xe mixed gas, at approximately 530 hPa to 800 hPa). At last, the parts including exhaust pipes are hermetically sealed and the evacuation step is completed.

As described above, in the exemplary embodiment of the present invention, in any of the step of forming display electrodes 6, the step of forming dielectric layer 8, and the step of disposing front plate 2 opposite to rear plate 10 for formation in the manufacturing process of PDP1, the temperature of at least front glass substrate 3 forming front plate 2 is set to a temperature at least 100° C. lower than the strain point temperature of front glass substrate 3. At this time, according to the types of glass substrate, the temperature may be set to 470° C. or lower, or to 410° C. or lower.

As a result, the residual stress in front glass substrate 3 of front plate 2 on the surface opposite to the surface on which dielectric layer 8 is disposed, i.e. the residual stress on the surface of the display side, can be maintained in the range of 0.8 MPa to 2.4 MPa, which is the residual stress in the initial state when the glass substrate is manufactured. Further, when the thickness of front glass substrate 3 is 2.8 mm±0.5 mm, the residual stress may be in the range of 1.3 MPa to 2.4 MPa. When the thickness of front glass substrate 3 is 1.8 mm±0.5 mm, it is preferable that the residual stress is in the range of 0.8 MPa to 1.7 MPa.

With these settings, the compressive stress residing in the glass substrate can be maintained. Thus PDP 1 having high strength and no panel cracks caused by an external force, such as shocks during transportation, can be obtained.

### EXAMPLE

Next, a description is provided for the advantage of the PDP of the exemplary embodiment of the present invention. Drop strength tests were conducted to verify the advantage of the exemplary embodiment. Specifically, PDP samples each having a screen 42-inch in diagonal were fabricated, packed in a manner similar to that of product shipment, dropped from a height of 50 cm with the image display surface disposed as the bottom face, and checked if the inside PDP samples wrapped with the packing material had cracks or not. The tests were conducted on 100 PDP samples manufactured by the conventional art, and 100 PDP samples in accordance with the exemplary embodiment of the present invention. In all the PDP samples of this Example, a glass substrate 1.8 mm±0.5 mm in thickness was used as front glass substrate 3.

According to the results of the drop strength tests, in six out of 100 PDP samples manufactured by the conventional art, front glass substrate 3 had cracks. On the other hand, in all the 100 PDP samples in accordance with the exemplary embodiment, front glass substrate 3 had no cracks.

The residual stress of front glass substrate 3 was measured in ten PDP samples of the conventional art, and ten PDP samples of the exemplary embodiment. According to the results, in front glass substrate 3 manufactured by the conventional art, the residual stress deviated from the proper range of 0.8 MPa to 1.7 MPa and substantially no stress was caused. In contrast, the residual stress of front glass substrate 3 manufactured by the method of the exemplary embodiment was within the above range.

This is considered to be based on the following reason. In the method for manufacturing the PDP of this exemplary embodiment of the present invention, front glass substrate 3 is manufactured at temperatures at least 100° C. lower than the strain point temperature of the glass substrate, and thus the residual stress caused in front glass substrate 3 at the beginning is maintained substantially without a decrease. As a result, PDP 1 has certain strength.

In the PDP samples of Example in accordance with the exemplary embodiment of the present invention, the quality level of image display in the initial state is equivalent to that of the PDP samples of the conventional art. Tests on the image display life corresponding to 60,000 hours were conducted on 3 PDP samples of Example. The results also show that the tested samples can maintain the quality level of image display equivalent to that of the PDP samples manufactured by the conventional art.

Like the PDP of the exemplary embodiment of the present invention, a PDP that has protective layer 9 formed of nano crystal particles 10 nm to 100 nm in average particle diameter can exhibit a higher strength as PDP 1 than a PDP that has a protective layer manufactured by the conventional EB vacuum evaporation method, for example.

Steel ball drop tests different from the above drop strength tests on the PDP were conducted on the image display surface, as strength tests on the PDP. The results of the steel ball drop tests show that, in PDP 1 that has a nano crystal particle layer having an average particle diameter of 10 nm to 100 nm as protective layer 9, the drop height of the steel ball at which panel cracks occur can be increased to 1.5 times the height of a PDP that has a protective layer manufactured by the conventional EB vacuum evaporation method.

This result is considered to be because protective layer 9 formed of nano crystal particles also serve as a shock adsorbing layer, and this effect remarkably appears at an average particle diameter of 10 nm to 100 nm. The drop height of the steel ball when the average particle diameter is out of this range is equivalent to that of the protective layer manufactured by the conventional EB vacuum evaporation method.

In accordance with the present invention, the thermal processes are performed at temperatures lower than those of the conventional art. Thus the present invention can advantageously suppress the occurrence of heat cracks in the glass substrate resulting from the temperature gradient in the glass substrate surface, in a firing furnace, for example.

In the exemplary embodiment of the present invention, examples of the preset temperature and processing time in each thermal process are described. However, the present invention is not limited to these settings. By manufacturing a PDP at temperatures at least 100° C. lower than the strain point temperature of front glass substrate 3, the residual stress in the glass substrate can be maintained at the residual stress in the initial state, and thus the advantage of the present invention can be provided.

### INDUSTRIAL APPLICABILITY

As described above, the present invention can provide a PDP where a glass substrate has a sufficient strength and occurrence of panel cracks is reduced, and thus is useful for a large-screen display device, for example.

1. A plasma display panel comprising:
a plurality of pairs of display electrodes, a dielectric layer, and a protective layer disposed on a front glass substrate,
wherein the protective layer is formed of nano crystal particles, and an average particle diameter of the nano crystal particles is in a range of 10 nm to 100 nm.

2. A method for manufacturing a plasma display panel, the plasma display panel having:
a front glass substrate formed of at least a display electrode, a dielectric layer, and a protective layer; and
a rear glass substrate,
wherein the front glass substrate and the rear glass substrate are faced each other and sealed with a sealing member, the method comprising:
a display electrode forming step of forming the display electrode on the front glass substrate;
a dielectric layer forming step of forming the dielectric layer on the front glass substrate so as to cover the display electrode;
a protective layer forming step of forming the protective layer so as to cover the dielectric layer; and
a sealing step of facing the front glass substrate including the protective layer and the rear glass substrate each other, and sealing them with the sealing member,
wherein, in the protective layer forming step, the protective layer is formed of nano crystal particles,
wherein, in any of the display electrode forming step, the dielectric layer forming step, the protective layer forming step, and the sealing step, the front glass substrate is treated at a temperature at least 100° C. lower than a strain point temperature of the front glass substrate.

3. The method for manufacturing the plasma display panel of claim 2,
wherein, in the display electrode forming step, a nano Ag paste is used as a material of the display electrode, and
in the sealing step, an ultraviolet (UV) curing material is used as a material of the sealing member.
